(19) United States
(12) Patent Application Publication
(10) Pub. No.: US 2025/0113951 A1
(43) Pub. Date: Apr. 10, 2025

(54) FOOD PROCESSING ATTACHMENT

(71) Applicant: DE'LONGCHI BRAUN HOUSEHOLD GMBH, Neu-Isenburg (DE)

(72) Inventors: Pascal WOHLFAHRT, Neu-Isenburg (DE); Christain DEXHEIMER, Neu-Isenburg (DE); Christof KLEEMANN, Neu-Isenburg (DE)

(21) Appl. No.: 18/730,941

(22) PCT Filed: Jan. 10, 2023
(86) PCT No.: PCT/EP2023/050430

§ 371 Date: Jul. 22, 2024

(30) Foreign Application Priority Data
Feb. 10, 2022 (GB) 2201745.3
Feb. 14, 2022 (LU) LU102909

(51) Int. Cl. A47J 43/044

(52) U.S. Cl. CPC A47J 43/044; A47J 2043/04427

(57) ABSTRACT

A food processing attachment includes a housing defining a processing volume, the housing having an open end, and a rotating processing tool extending into the housing from a floor region opposite the open end, at least one opening being formed in the housing and spaced from the open end.

### FIELD

The present invention relates to a food processing attachment, and more specifically to such an attachment for a hand held appliance such as a hand blender.

Hand blenders known as wand or stick blenders are hand held appliances having a rotating cutting blade beneath a housing or cover which may be bell-shaped at the distal end of a wand or stick. The housing defines a processing volume, and protects the blade from undesired contact. The blade assembly and cover may be attached to a wand or stick, optionally removably, which is usually connected or connectable to a motor unit at the proximal end of the stick which forms part of a handle for the user to grasp.

Most hand blenders currently available are of a similar size to each other, to be suitable for blending material in common kitchen cooking containers such as a saucepan or bowl, where the user lowers the distal end into the material in the container in order to process the material. They are therefore optimized for processing larger amount of foods such as would be held in such a cooking container.

There are however some applications where only small volumes of food need to be processed. For example blending single portions of food or baby food, or the emulsifying of mayonnaise or other dressings and sauces. For those small volume applications, regular hand blenders can deliver only insufficient results.

Some solutions which have been proposed for processing small volumes have other limitations.

Specialized emulsifying attachments, for example described in U.S. Pat. No. 8,337,072, can offer good emulsifying results, but cannot be used for blending small quantities of food. Specialized small wands have also been offered, which are optimized for blending, but these do not offer good emulsifying performance.

Currently there is a need for an attachment which offers good performance both for blending of small quantities of material, and also for emulsifying.

### SUMMARY OF INVENTION

The present invention provides a food processing attachment comprising a housing defining a processing volume, the housing having an open end, and a rotating processing tool extending into the housing from a floor region opposite the open end, and at least one opening formed in the housing and spaced from the open end.

For example, the or each opening may be formed in a peripheral wall of the housing between the floor region and the open end. The wall may be substantially cylindrical in shape.

The tool may comprise at least one cutting blade, which may be mounted on a rotary shaft extending from the housing floor, preferably centrally. The tool blade or blades may extend outwardly towards the wall of the housing. The or each opening may be positioned substantially between the housing floor and the tool. The or each opening in the housing comprises an aperture which allows material drawn into the housing through the open end by rotation of the tool to be ejected, thus improving emulsification.

Preferably, the open end of the housing comprises at least one undulation for providing a respective passage for material being processed, and the or each opening may be provided in a region between the or each undulation.

The cover or bell may for example have three openings in the upper area of the side walls, which are not present on existing blending bells. The openings may be spaced evenly in between the passages or cut outs in the lower area or open end of the bell, for example so as to be offset from each the cut outs by 60° where there are three openings. This assists in providing mechanical strength in the bell and a better exchange of blending material resulting from the rotary movement of the knife to the openings. The knife creates a suction force, which draws in foodstuff through the cutouts in the lower edge and ejects it through the openings in the side wall. This assists with the emulsifying process.

The bell is preferably smaller than a conventional blending bell, having a smaller inner volume, so as to facilitate use for emulsifying, whilst being large enough for blending small quantities in small containers.

For example the inner diameter of the bell may be a maximum of between about 40 mm and 45 or 50 mm, preferably less than 45 mm, for example 44.5 mm. The bell may have a diameter/height ratio of less than three, preferably between 1 or 1.5 and 3, and more preferably between 2 and 2.5 or 3, for example around 2.5. Thus the inner height of the processing volume may be less than 19 to 21 mm, preferably between 17 and 21 mm or between 18 and 20 mm, for example around 18.8 mm.

The configuration of the upper interior surface or floor of the inside of the bell assists the suction and ejecting action by decreasing the inner volume of the bell and directing the blended material out of the bell with the help of ribs.

For example, the floor region may comprise a substantially disc shaped element having at least one rib extending into the processing volume so as to form a region of the processing volume of reduced height. The or each rib is preferably aligned with the or each opening, and may be positioned adjacent the edge of the housing, and/or may extend radially either from the centre of the floor or from a position radially spaced from the centre, for example at least around half way between the centre and the edge of the floor. The or each rib extends towards at least one of the at least one cutting blade in use so as to reduce the distance between the blade and the floor.

Thus the ribs may be provided directly adjacent the openings, so as to minimize in these areas the height and volume of the bell. This increases the suction effect causing the blended material to be ejected much faster and more easily. This may have the advantage of significantly improving not only the blending process, but also the emulsification process, and to simplify and significantly speed up the emulsification process due to the higher suction effect.

The ribs thus serve two functions. When blending solid food stuffs, the ribs form a barrier in the path of the knife, so as to help prevent food particles from co-rotating with the knife, or at least to slow down the rotation of food particles, resulting in a higher relative speed between knife and food, and as a result finer and faster blending. In combination with the cut-outs in the side wall, particularly when processing liquids the ribs serve a second function. The ribs reduce the volume in the area above the cut-out, forcing more liquid out through the cut-outs, leading to a better exchange of liquid inside and outside the bell and therefore resulting in a better emulsifying result.

This effect can be used in any device, kitchen appliance or food processor where blending or emulsification is to be performed with a rotating blade, such as a hand blender, jug blender, chopper, etc. Thus the food processor or appliance may be a hand-held kitchen appliance, preferably a hand blender.

The attachment preferably has a drive connector for providing rotary drive to the processing tool from an appliance body. For example, the attachment may be removably attachable to a food processor body comprising a motor unit.

The invention also provides a food processor comprising a motor unit arranged to be hand-held, and a food processing attachment as defined herein. For example, the food processing attachment may be attachable to the distal end of an elongate handle.

The described mode of action between the openings in the bell and the ribs provides an advantage over the previous bell structures. In previous structures, the focus has been on the blending process, such that ribs were provided to interact with the knife to achieve a good blending outcome. In contrast to the blending process, during the emulsification process, the knife acts as a stirring or agitating aid to unite the foodstuffs to be emulsified, wherein an emulsifier forms a shell around an oily foodstuff in order for it to combine with the aqueous foodstuff. With this invention, the action between the ribs and the openings may achieve good and fast emulsion.

The invention also encompasses a kit of parts for constructing any of the apparatuses or apparatus elements herein described.

The invention extends to methods, system and apparatus substantially as herein described and/or as illustrated with reference to the accompanying figures.

The invention extends to any novel aspects or features described and/or illustrated herein.

Any apparatus feature as described herein may also be provided as a method feature, and vice versa. As used herein, means plus function features may be expressed alternatively in terms of their corresponding structure, such as a suitably programmed processor and associated memory, for example.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination. It should also be appreciated that particular combinations of the various 10 features described and defined in any aspects of the invention can be implemented and/or supplied and/or used independently.

It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

As used herein, the term “removable attachment” (and similar terms such as “removably attachable” and “reversibly attachable”), as used in relation to an attachment between a first object and a second object, preferably connotes that the first object is attached to the second object and can be detached (and preferably re-attached, detached again, and so on, repetitively), and/or that the first object may be removed from the second object without damaging the first object or the second object; more preferably the term connotes that the first object may be re-attached to the second object without damaging the first object or the second object, and/or that the first object may be removed from (and optionally also re-attached to) the second object by hand and/or without the use of tools (e.g. screwdrivers, spanners, etc.). Mechanisms such as a snap-fit, a bayonet attachment, and a hand-rotatable locking nut may be used in this regard.

Furthermore, features implemented in hardware may generally be implemented in software, and vice versa. Any reference to software and hardware features herein should be construed accordingly.

Whilst the invention has been described in the field of domestic food processing and preparation machines, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances. Any reference to “food”, “foodstuff” or similar terms herein may be replaced by such working mediums.

The invention described here may be used in any kitchen appliance and/or as a stand-alone device. This includes any domestic food-processing and/or preparation machine, including both top-driven machines (e.g. stand-mixers) and bottom-driven machines (e.g. blenders or food processors). It may be implemented in heated and/or cooled machines. The invention may also be implemented in both hand-held (e.g., hand blenders) and table-top (e.g., blenders) appliances. It may be used in an appliance that is built-in to a work-top or work surface, or in a stand-alone device. The invention can also be provided as a stand-alone device, whether motor-driven or manually powered.

As used herein, the term “processing” preferably connotes any action relating to or contributing towards transforming products into foodstuff, or transforming foodstuff into a different form of foodstuff, including—as examples—applying mechanical work (e.g. for cutting, beating, blending, whisking, dicing, spiralizing, grinding, extruding, shaping, kneading etc.) and applying heat or cold. “Food” and “foodstuff” as used herein can include beverages and frozen material and material used in creating them (e.g., coffee beans).

### BRIEF DESCRIPTION OF DRAWINGS

The invention will now be described by way of example with reference to the accompanying drawings in which:

FIG. 1 is a perspective view of a blender attachment;

FIG. 2 is a side view of a blender attachment bell according to the prior art;

FIG. 3 is an underneath perspective view of the attachment of FIG. 1;

FIG. 4 is an underneath view or the attachment of FIG. 1;

FIG. 5 is a schematic sectional side view of the attachment of FIG. 1, showing the region boxed in FIG. 3;

FIG. 6 is a schematic sectional side view of a floor member of the attachment of FIG. 1.

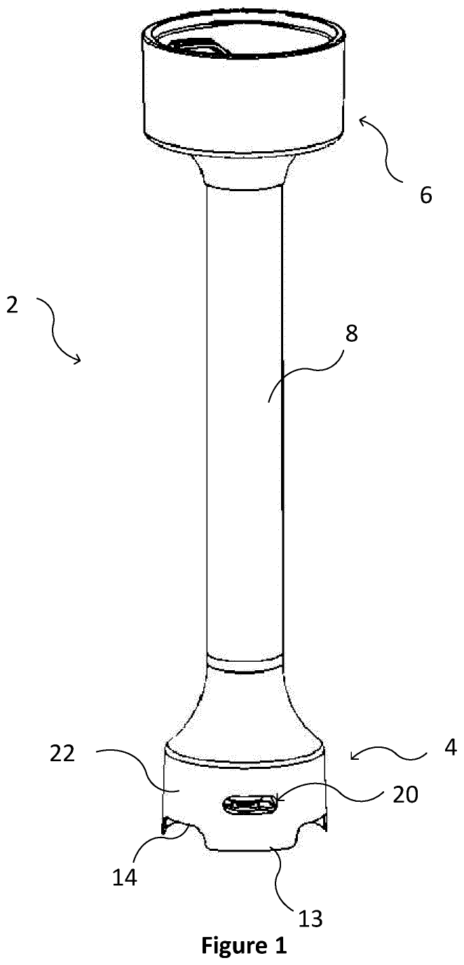

Referring to FIG. 1, a hand blender attachment 2 comprises a blending bell 4 at a distal end, which is attached to a connecting piece 6 at a proximal end for attachment to a motor unit (not shown) by a wand or stick 8. The bell 4 defines a processing volume therein, with a rotating tool 5 extending into the processing volume from a floor 10 of the interior of the bell 4, as shown in FIG. 3. The bell 4 is circular in shape, and has a wall 22 extending between the floor 10 and an open end 12. The wall 22 may be substantially cylindrical in shape.

The open end 12 has crenellations or undulations 13 providing passages 14 therebetween for material being processed. The bell 4 may have an exterior curved surface 9 forming a smooth transition between the side wall 22 and the stick 8.

The bell 4 may have a smaller diameter than a conventional blending bell. For example the diameter may be a maximum of between about 45 mm and 50 mm. The attachment may be provided with a small beaker of a suitable diameter for optimal use of the attachment.

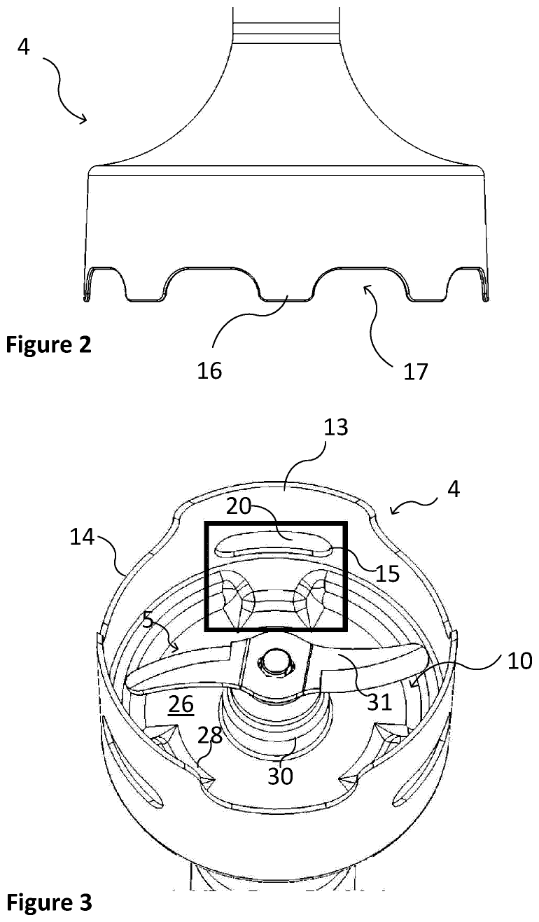

As can be seen in FIG. 2, for a conventional bell 18, when placed on the base of a container, all material flowing into and out of the processing volume passes though passages 17 created between the crenellations or undulations 16.

The bell 4 of the attachment of FIG. 1 additionally includes openings 20 in the bell housing spaced from the open end, for example in the side wall 22. There may be a plurality of such openings 20, in this example three, and these may be evenly spaced, in this example around the side wall 22 of the bell 4. The openings 20 may be provided aligned with the crenellations 13, in the region between the passages 14. They may be elongate in shape, extending circumferentially, and have a rounded profile at each end 15 to allow smooth flow of material.

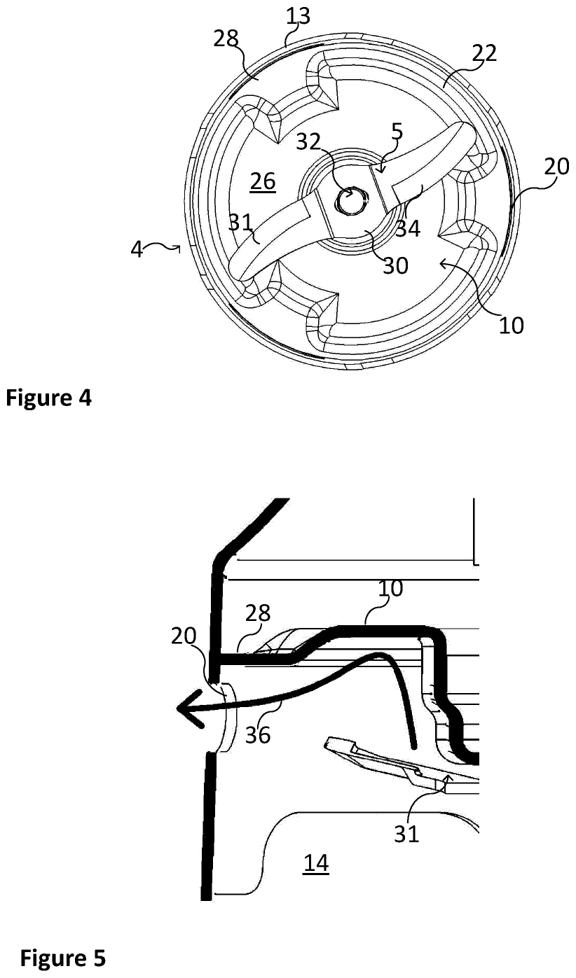

Referring also to FIGS. 3 to 5, the floor 10 of the bell 4 opposite the open end includes a substantially flat portion 26 bearing ribs 28. The ribs 28 extend from adjacent the side wall 22 part way towards a tool mount 30 which holds a drive shaft 32 of the tool 5, which is provided in a central part of the floor 10.

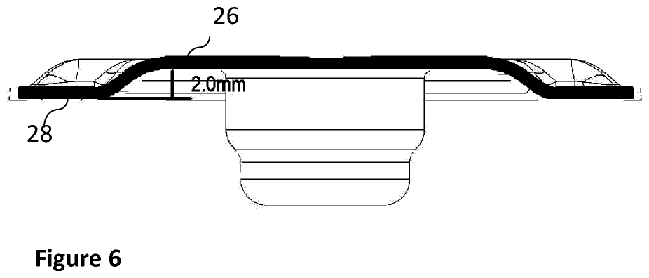

The ribs 28 are advantageously aligned with the opening 20, between the opening 20 and the floor 10, such that the openings 20 are positioned between each rib 28 and the open end of the bell 4. The ribs 28 are preferably also aligned with the crenellations 13. As can be seen from FIG. 6, the ribs 28 may extend axially away from the base 26 of floor by around 2 mm. The floor 10 may be a substantially disc shaped member mounted within the bell 4.

The tool 5 may be a conventional bladed blending tool, which may have two or more blades 31 extending outwardly from the tool shaft 32, and may be angled slightly towards the floor 10. In this example, the blades have curved sharpened edges 34 which form cutting edges when the tool 5 is rotated by the motor. The curved edges 34 may be swept back, for example at an angle of about 25 degrees from the radial direction.

Operation of the attachment is as follows. When the tool 5 rotates with the attachment submerged in material to be processed, the action of the tool 5 creates suction which causes the material to enter the processing volume from the open end, via the passages 14 between the crenellations 13 when the attachment is placed on a flat surface such as the base of a container.

Referring to FIG. 5, the material flows in the direction of the arrow 36 past the blade 31 towards the base 26 of the floor 10. The material is then deflected outwardly and into a region of reduced volume over the ribs 28, which causes an increase in the flow speed such that the material is ejected through the openings 20. This provides a better exchange of material, in particular liquid, than prior bells not having openings in the bell housing.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1-20. (canceled)

21. A food processing attachment comprising a housing defining a processing volume, the housing having an open end, and a rotating processing tool extending into the housing from a floor region opposite the open end, at least one opening being formed in the housing and spaced from the open end.

22. The food processing attachment as claimed in claim 21, in which the opening is formed in a peripheral wall of the housing which extends between the floor region and the open end.

23. The food processing attachment as claimed in claim 22, in which the processing tool comprises at least one cutting blade mounted to a rotary shaft extending from the housing floor.

24. The food processing attachment as claimed in claim 23, in which the cutting blade extends across the housing towards the periphery.

25. The food processing attachment as claimed in claim 21, in which the open end of the housing comprises at least one undulation for providing a respective passage for material being processed.

26. The food processing attachment as claimed in claim 25, in which the opening is provided between the or each undulation.

27. The food processing attachment as claimed in claim 25, in which the undulation extends in an axial direction by between about 4 and 10 mm, preferably between about 5 and 7 mm, and more preferably about 6 mm.

28. The food processing attachment as claimed in claim 21, in which the floor region comprises at least one rib extending into the processing volume so as to form a region of the processing volume of reduced height.

29. The food processing attachment as claimed in claim 28, in which the rib is aligned with the or each opening.

30. The food processing attachment as claimed in claim 28, in which the rib extends towards at least one of the at least one cutting blade in use so as to reduce the distance between the blade and the floor.

31. The food processing attachment as claimed in claim 30, in which the rib extends between 1 and 4 mm, preferably 2 mm, from the floor.

32. The food processing attachment as claimed in claim 30, in which the distance between the blade and the rib is between about 8 and 12 mm, preferably between 9 and 11 mm, and more preferably 10 mm.

33. The food processing attachment as claimed in claim 28, in which the openings, the undulations and the ribs are of the same number, preferably three.

34. The food processing attachment as claimed in claim 21, in which the housing has a cylindrical side wall.

35. The food processing attachment as claimed in claim 21, in which the diameter of the housing does not exceed 60 mm, and is preferably between 45 mm and 50 mm.

36. The food processing attachment as claimed in claim 21, in which the floor comprises a floor element which is spaced from an exterior surface of the housing.

37. The food processing attachment as claimed in claim 21, having a drive connector for providing rotary drive to the processing tool.

38. The food processor as claimed in claim 37, in which the housing is removably attachable to a food processor body comprising a motor unit.

39. The food processor comprising a motor unit arranged to be hand held, and a food processing attachment as claimed in claim 21.

40. The food processor as claimed in claim 39 in which the food processing attachment is attachable to the distal end of an elongate handle.
